(19) United States
(12) Patent Application Publication
(10) Pub. No.: US 2011/0085661 A1
(43) Pub. Date: Apr. 14, 2011

(54) CONTENT RECEIVING TERMINAL, CONTENT REPRODUCING TERMINAL, CONTENT WRITE-OUT METHOD, AND PROGRAM

(76) Inventor: Hisashi TSUJI, Osaka (JP)

(21) Appl. No.: 12/816,590

(22) Filed: Jun. 16, 2010

(30) Foreign Application Priority Data
Oct. 14, 2009 (JP) 2009-236924

(51) Int. Cl. H04N 7/167; H04L 9/08

(52) U.S. Cl. 380/210; 380/279

(57) ABSTRACT

During the export processing for the video content (S107), the content receiving terminal causes an encryption key for content stored in the recording medium, to be present in the content receiving terminal (S103, S105, and S106). Only when the export processing is completed or when suspension processing is normally performed, the content receiving terminal writes the content encryption key in the recording medium (S111 and S112). When the export processing is abnormally suspended, since the content encryption key is not stored in the recording medium, the other video reproducing terminals cannot reproduce the video content for which the export is incomplete.

### FIELD OF THE INVENTION

The present invention relates to a video delivery system including a video delivery server and a content receiving terminal which downloads video and sound contents and the like from the video delivery server via a communication network, and, more particularly to a content receiving terminal and the like which can write (export) downloaded content to a recording medium.

### BACKGROUND OF THE INVENTION

In recent years, video delivery services using communication networks (communication lines) are becoming popular. In a video delivery system including a video delivery apparatus (a video server) for delivering videos and the like, a communication line including a global network such as the Internet and a home network, and a video receiving terminal connected to the home network, a user can use, by operating the video receiving terminal as a terminal for viewing videos, a VOD (Video On Demand) service, an IP (Internet Protocol) broadcast, a video download service, and the like ,such services being provided by a communication carrier, a video delivery carrier, and the like by using a video delivery server and the like.

Further, in the video download service, such service is also performed that downloaded video content is exported to a recording medium and the video content is viewed in a video reproducing terminal different from the video receiving terminal.

However, when the video content is exported to the recording medium, if an accident such as turning-off of a power supply for the video receiving terminal occurs, export processing executed by the video receiving terminal is abnormally suspended. In that case, miswritten video content is left in the recording medium. When the left video content is reproduced by another video reproducing terminal, it is likely occurred depending on how the content is left and how the content is reproduced, that unexpected problems of the video reproducing terminal such as illegal use of a license granted to the video content, occur. Therefore, in the export processing of the video content, it is an extremely important object that the video receiving terminal and the video reproducing terminal correctly perform suspension control.

Conventionally, as one of methods for correctly controlling the video content for which the export processing abnormally ends in this way, Patent Document 1 discloses a related art of such a method.

Patent Document 1 (Japanese Patent Application Laid-Open No. 2006-285327) assumes a case in which digital data such as video content is recorded in a recording apparatus. The recording apparatus is provided with a recording medium which records the video content and a nonvolatile recording unit which records a data amount of the video content recorded in the recording medium. The entire disclosure of the Document 1 is incorporated herein by reference in its entirety.

A video content recording procedure of the Patent Document 1 is described next. The recording apparatus records the video content in the recording medium and records the data amount and a data writing position of the recorded data in the recording medium, in the nonvolatile recording unit. The recording apparatus makes it possible to, even if video content recording processing is abnormally suspended because of occurrence of blackout etc., store the written data amount and data writing position in the nonvolatile recording medium and to read the video content normally recorded up to that point. Accordingly the video reproducing terminal can determine to which portion the digital data recorded halfway, can be reproduced. In this way, according to the technique of the Patent Document 1, it is possible to perform appropriate suspension control for the export processing.

However, in the conventional suspension processing control method disclosed in the Patent Document 1, it is likely that a malicious user intentionally causes abnormal suspension during the exporting of the video content and illegally uses the video content for which the exporting is incomplete. Even if reproduction control for the export-incomplete video content is attempted on the video receiving terminal side, it is considered to be likely that an unjust video reproducing terminal illegally performs reproduction.

The present invention has been devised in view of such problems of the conventional suspension processing control method and it is an object of the present invention to provide a content receiving terminal, a content reproducing terminal, a content write-out method, and the like which can adequately perform the export processing for the content so that the content cannot be illegally reproduced in the content reproducing terminal, even if processing for exporting content to a recording medium is abnormally suspended because of blackout or the like in the content receiving terminal which can download content delivered via a communication network and export the downloaded content to the recording medium.

### SUMMARY OF THE INVENTION

The 1^{st} aspect of the present invention is a content receiving terminal which encrypts content by using an encryption key and records the encrypted content in a recording media together with the encryption key, the content receiving terminal comprising:

a request receiving unit which receives a write-out request for the content from a user;

a content encryption key storing unit which stores the content encryption key; and

a control unit which controls write-out of the content and the encryption key to the recording media including a content recording section and a content encryption key recording section , wherein

the control unit includes a unit which can perform transmission and reception with at least the request receiving unit, the content encryption key storing unit, and the recording media, and determine whether the content encryption key is present in the content encryption key recording section, and

the control unit further

does not record, when the encrypted content is recorded in the content recording section of the recording media according to the write-out request for the content, the encryption key in the content encryption key recording section of the recording media but stores the encryption key in the content encryption key storing unit of the content receiving terminal,

moves, when processing for recording the encrypted content in the content recording section of the recording media is normally temporarily suspended, the encryption key stored in the content encryption key storing unit of the content receiving terminal, to the content encryption key recording section of the recording media,

does not move, when the processing for recording the encrypted content in the content recording section of the recording media is abnormally temporarily suspended, the encryption key stored in the content encryption key storing unit of the content receiving terminal, to the content encryption key recording section of the recording media,

moves, when the recording of the encrypted content is continued, if the encryption key is recorded in the content encryption key recording section of the recording media, the encryption key, to the content receiving terminal, encrypts the content, and continuously records the encrypted content in the recording media, and

moves, when the recording of the encrypted content in the recording media is completed, the encryption key, to the content key recording section of the recording media.

The 2^{nd} aspect of the present invention is the content receiving terminal according to the 1^{st} aspect of the present invention, wherein

the control unit further includes a unit which determines whether the content encryption key is present in the content encryption key storing unit, and

the control unit encrypts, when the recording of the encrypted content is continued, if the encryption key is not recorded in the content key recording section of the recording media and the encryption key is stored in the content key storing unit of the content receiving terminal, the content by using the stored encryption key and continuously records the encrypted content in the recording media.

The 3^{rd} aspect of the present invention is the content receiving terminal according to the 2^{nd} aspect of the present invention, further comprising an encryption key acquiring unit which acquires an encryption key anew, wherein

the control unit acquires, when the encryption key is recorded neither in the content key recording section of the recording media nor in the content key storing unit of the content receiving terminal, an encryption key anew by the encryption key acquiring unit, encrypts the content from the beginning on the basis of the encryption key acquired anew, and performs recording of the encrypted content.

The 4^{th} aspect of the present invention is the content receiving terminal according to the 3^{rd} aspect of the present invention, wherein

the control unit stores, when an encryption key is created anew, the encryption key in the content encryption key storing unit of the content receiving terminal.

The 5^{th} aspect of the present invention is a content reproducing terminal having a function reproducing content stored in a recording media in which the content is written by the content receiving terminal according to the 1^{st} aspect of the present inventions,

the content reproducing terminal comprising a reproduction control unit which recognizes whether write-out processing for the content normally ends or abnormally ends by checking whether the encryption key for performing decryption of the content is present in the content encryption key recording section of the recording media or not.

The 6^{th} aspect of the present invention is a content reproducing terminal having a function reproducing content stored in a recording media in which the content is written by the content receiving terminal according to the 2^{nd} aspect of the present inventions,

the content reproducing terminal comprising a reproduction control unit which recognizes whether write-out processing for the content normally ends or abnormally ends by checking whether the encryption key for performing decryption of the content is present in the content encryption key recording section of the recording media or not.

The 7^{th} aspect of the present invention is a content reproducing terminal having a function reproducing content stored in a recording media in which the content is written by the content receiving terminal according to the 3^{rd} aspect of the present inventions,

the content reproducing terminal comprising a reproduction control unit which recognizes whether write-out processing for the content normally ends or abnormally ends by checking whether the encryption key for performing decryption of the content is present in the content encryption key recording section of the recording media or not.

The 8^{th} aspect of the present invention is a content reproducing terminal having a function reproducing content stored in a recording media in which the content is written by the content receiving terminal according to the 4^{th} aspect of the present inventions,

the content reproducing terminal comprising a reproduction control unit which recognizes whether write-out processing for the content normally ends or abnormally ends by checking whether the encryption key for performing decryption of the content is present in the content encryption key recording section of the recording media or not.

The 9^{th} aspect of the present invention is a write-out method for content in a content receiving terminal which encrypts content by using an encryption key and records the encrypted content in a recording media together with the encryption key,

the write-out method comprising:

not recording, when the encrypted content is recorded in the recording media, the encryption key, in the recording media but storing the encryption key in the content receiving terminal;

moving, when processing for recording the encrypted content in the recording media is normally temporarily suspended, the encryption key stored in the content receiving terminal, to the recording media;

not moving, when the processing for recording the encrypted content in the recording media is abnormally temporarily suspended, the encryption key stored in the content receiving terminal, to the recording media;

moving, when the recording of the encrypted content is continued, if the encryption key is recorded in the recording media, the encryption key, to the content receiving terminal, encrypting the content, and continuously recording the encrypted content in the recording media; and

moving, when the recording of the encrypted content in the recording media is completed, the encryption key to the recording media.

The 10^{th} aspect of the present invention is the content write-out method according to the 9^{th} aspect of the present invention, further comprising

encrypting, when the recording of the encrypted content is continued, if the encryption key is not recorded in the recording media and the encryption key is stored in the content receiving terminal, the content by using the stored encryption key and continuously recording the encrypted content in the recording media.

The 11^{th} aspect of the present invention is the content write-out method according to the 10^{th} aspect of the present invention, further comprising

creating, when the encryption key is recorded neither in the recording media nor in the content receiving terminal, an encryption key anew, encrypting the content from the beginning on the basis of the encryption key created anew, and performing recording of the encrypted content.

The 12^{th} aspect of the present invention is the content write-out method according to the 11^{th} aspect of the present invention, further comprising

storing, when the encryption key is created anew, the encryption key in the content receiving terminal.

The 13^{th} aspect of the present invention is a program embodied on a non-transitory and tangible computer-readable medium, the program causing a computer to execute;

a write-out method for content in a content receiving terminal which encrypts content by using an encryption key and records the encrypted content in a recording media together with the encryption key, the write-out method comprising:

not recording, when the encrypted content is recorded in the recording media, the encryption key, in the recording media but storing the encryption key in the content receiving terminal;

moving, when processing for recording the encrypted content in the recording media is normally temporarily suspended, the encryption key stored in the content receiving terminal, to the recording media;

not moving, when the processing for recording the encrypted content in the recording media is abnormally suspended, the encryption key stored in the content receiving terminal, to the recording media;

moving, when the recording of the encrypted content is continued, if the encryption key is recorded in the recording media, the encryption key, to the content receiving terminal, encrypting the content, and continuously recording the encrypted content in the recording media; and

moving, when the recording of the encrypted content in the recording media is completed, the encryption key to the recording media.

As described above, according to the content receiving terminal, the content reproducing terminal, the content write-out method, and the like, of the present invention, when abnormal suspension occurs during the export processing, the content receiving terminal can control the reproduction permission for export-incomplete content and prevent an illegal operation in the reproducing of the content.

### BRIEF DESCRIPTION OF THE DRAWINGS

FIG. 1 is a block diagram showing the configuration of a video receiving terminal according to an embodiment of the present invention.

FIG. 2 is a block diagram showing a schematic view of the video receiving terminal according to the embodiment of the present invention.

FIG. 3 is a block diagram showing the configuration of a video reproducing terminal according to the embodiment of the present invention.

FIG. 4 is a flowchart showing a procedure for performing export of video content in the video receiving terminal according to the embodiment of the present invention.

FIG. 5 is a flowchart showing a procedure for determining reproduction permission of video content in the video reproducing terminal according to the embodiment of the present invention.

### REFERENCE SIGNS LIST

100 video receiving terminal
101 request receiving unit (201)
102 download control unit
103 communication unit
104 buffer unit
105 export control unit
106 media control unit (203)
107 recording media
108 content recording section
109 content encryption key recording section
110 content encryption key storing unit
120 control unit
150 video server
200 video reproducing terminal
202 reproduction control unit

### DETAILED DESCRIPTION

An embodiment of the present invention is described with reference to the drawings.

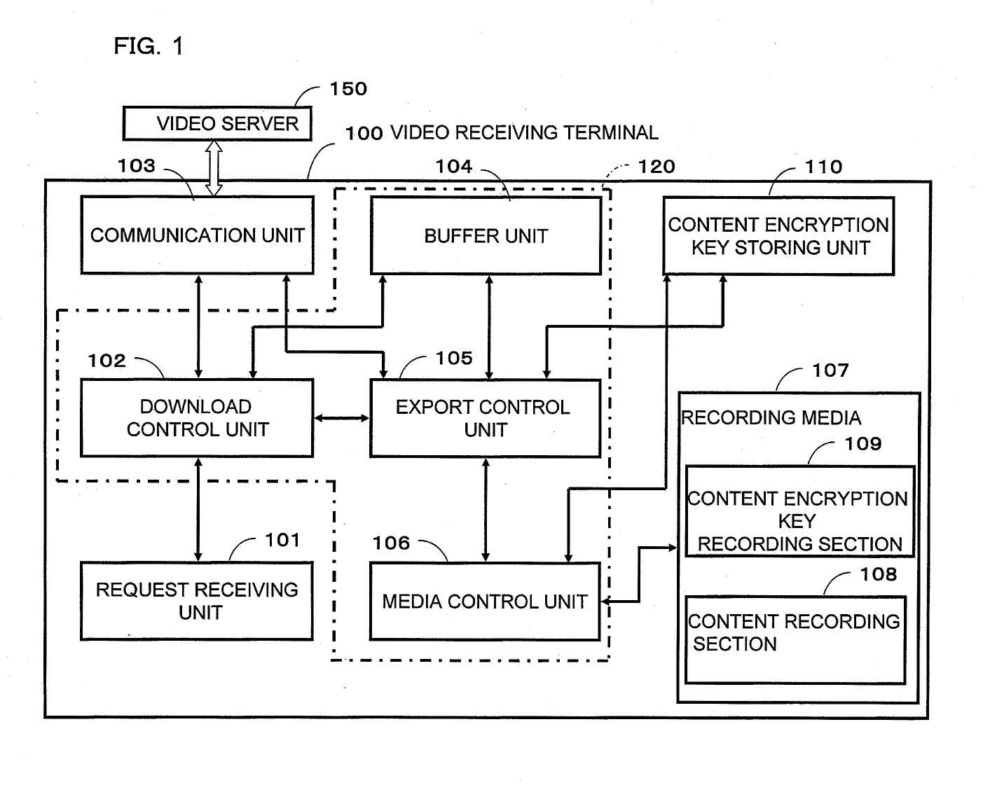

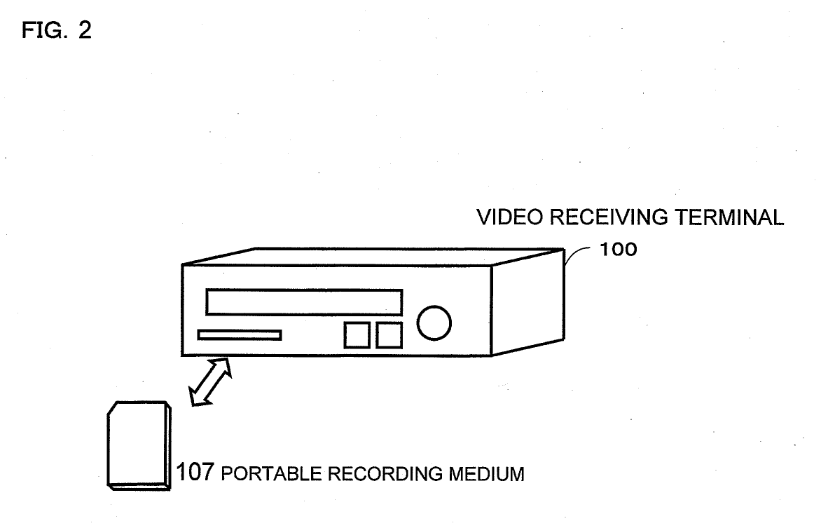

FIG. 1 is a block diagram showing the configuration of a video receiving terminal according to the embodiment of the present invention. The video receiving terminal is described below with reference to FIGS. 1 and 2 as an example of the content receiving terminal of the present invention.

In FIG. 1, a video receiving terminal 100 according to this embodiment includes a request receiving unit 101 which receives a request for download, a download control unit 102 which controls the download, a communication unit 103 which performs communication with outside, a buffer unit 104 which temporarily records content data, an export control unit 105 which controls export, a media control unit 106 which controls a recording media 107 such as a CD, and a content encryption key storing unit 110 which stores an encryption key for encrypting the content data.

Even if export processing for the video content is abnormally suspended during the export processing, the video receiving terminal 100 can control the reproduction permission of video content for which the export is incomplete.

The recording media 107 is provided with a content recording section 108 which records the content data and a content encryption key recording section 109 which records the encryption key for encrypting the content data.

The video receiving terminal 100 is a video receiving terminal having a function which can receive a download service for video content provided by a communication carrier, a video delivery carrier, or the like via a communication network and having a function which can export the downloaded video content to a recording medium such as a CD. As such a video receiving terminal, a digital television, a Set Top Box, a personal computer, and the like, are conceivable. However, the video receiving terminal is not limited to these apparatuses.

The video receiving terminal 100 acquires the video content through the communication network as described above. However, the video receiving terminal 100 may acquire the video content from any medium such as a hard disk in which the video content is already stored.

FIG. 2 is a conceptual diagram showing a state in which the recording media 107 such as a CD is removed from the video receiving terminal 100.

The video receiving terminal 100 according to this embodiment is described more in detail below.

The request receiving unit 101 is a unit which receives a video content export request and an export suspension request from the outside by remote controller operation or the like of a user and which transmits the received requests to the download control unit 102.

The download control unit 102 is a unit which requests, when it receives the video content export request (there are two cases of the case of first export request and the case of reopening and continuation of export) from the request receiving unit 101, the communication unit 103 to download video content from the video server 150.

The communication unit 103 is a unit which acquires, in response to the video content export request received from the download control unit 102, video content from the video server 150 and sends the acquired video content to the download control unit 102 through the communication network.

The download control unit 102 temporarily stores the video content acquired from the communication unit 103 in the buffer unit 104. At the same time, the download control unit 102 transmits the video content export request to the export control unit 105 in order to request the export control unit 105 to export the downloaded video content to the recording media 107.

On the other hand, when an export suspension request is received from the request receiving unit 101, the download control unit 102 suspends the download of the content and transmits the export suspension request to the export control unit 105.

The buffer unit 104 is a unit which temporarily stores the video content transmitted from the download control unit 102.

The export control unit 105 is a unit which acquires, when the video content export request is received from the download control unit 102, the video content from the buffer unit 104.

The export control unit 105 applies encryption to the acquired video content, transmits the video content to the media control unit 106, and, at the same time, transmits the video content export request to the media control unit 106.

The media control unit 106 is a unit which receives the video content export request from the export control unit 105 and writes video content in the content recording section 108 in the recording media 107. The media control unit 106 is a unit which stores the encryption key for encrypting content in the content encryption key recording section 109 in the recording media 107.

The recording media 107 is a medium which records the video content. As this medium, a CD (Compact Disc), a DVD (Digital Versatile Disc), a BD (Blu-ray disc (registered trademark)), an SD memory card (Secure Digital Memory Card), a memory stick, and the like are conceivable. However, the recording media 107 is not limited to these media. Usually, the recording media 107 is a portable medium.

The content recording section 108 is a section in which the video content encrypted by the export control unit 105, is recorded.

The content encryption key recording section 109 is a section in which the encryption key with which the video content is encrypted is stored by the media control unit 106.

The content encryption key storing unit 110 is a unit which stores, for example, the encryption key extracted from the content encryption key recording section 109 in the recording media 107. The media control unit 106 performs processing for extracting the encryption key.

The control unit according to the present invention corresponds to the download control unit 102, the export control unit 105, and the media control unit 106.

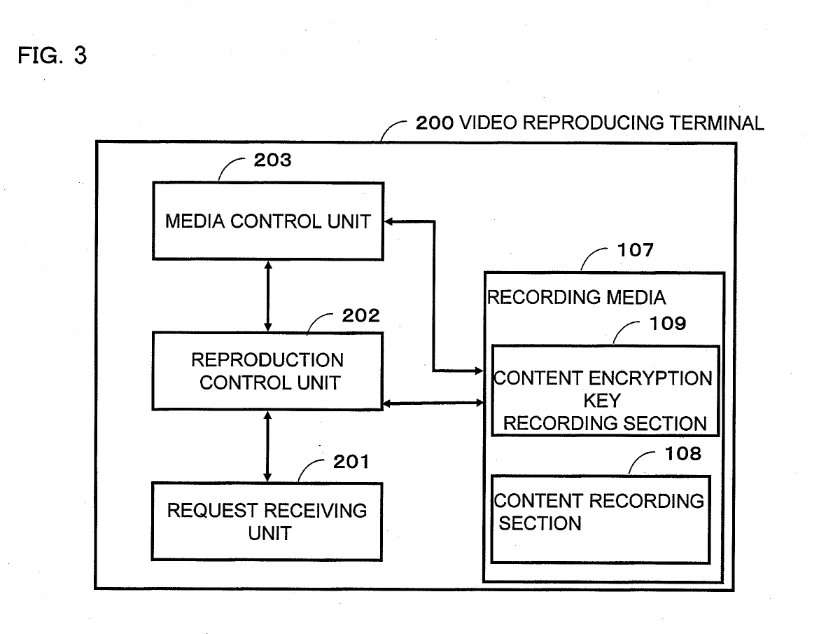

FIG. 3 is a block diagram showing the configuration of a video reproducing terminal according to this embodiment.

In FIG. 3, a video reproducing terminal 200 according to this embodiment is provided with a request receiving unit 201 which receives a request for video content reproduction, a reproduction control unit 202 which controls reproduction of video content, and a media control unit 203 which controls a medium. The video reproducing terminal 200 has a function of checking whether video content recorded in the content recording section 108 is video content recorded when the export processing is abnormally suspended or not and of determining reproduction permission for the video content.

The recording media 107 has the content recording section 108 in which content data is recorded and the content encryption key recording section 109 which records the encryption key. The recording media 107 is the recording media 107, for example a CD, which has been set in the video receiving terminal 100 shown in FIG. 1, and been taken out, and is set in the video reproducing terminal 200. Descriptions of the content recording section 108 and the content encryption key recording section 109 are omitted because the content recording section 108 and the content encryption key recording section 109 are the same as those shown in FIG. 1.

The video reproducing terminal 200 is a video reproducing terminal having a function which can reproduce video content recorded in a recording medium. As such a video reproducing terminal, a digital television, a Set Top Box, a personal computer, a portable reproducing apparatus, and the like are conceivable. However, the video reproducing terminal is not limited to these apparatuses.

Next, the configuration of the video reproducing terminal 200 is described more specifically.

The request receiving unit 201 is a unit which receives a video content reproduction request from outside by remote controller operation or the like by a user and transmits the received request to the reproduction control unit 202.

The reproduction control unit 202 is a unit which receives the video content reproduction request from the request receiving unit 201 and performs reproduction of a video content when the video content is permitted to be reproduced.

That is the reproduction control unit 202 transmits a presence check request for a content encryption key, to the media control unit 203 before reproduction processing, in order to determine whether the video content may be reproduced or not.

The media control unit 203 is a unit which receives the received presence check request for the content encryption key from the reproduction control unit 202 and checks whether the content encryption key is stored or not in the content encryption key recording section 109 in the recording media 107. The media control unit 203, which has finished the check, returns a result to the reproduction control unit 202.

The reproduction control unit 202 receives the check result from the media control unit 203 and performs reproduction according to the check result.

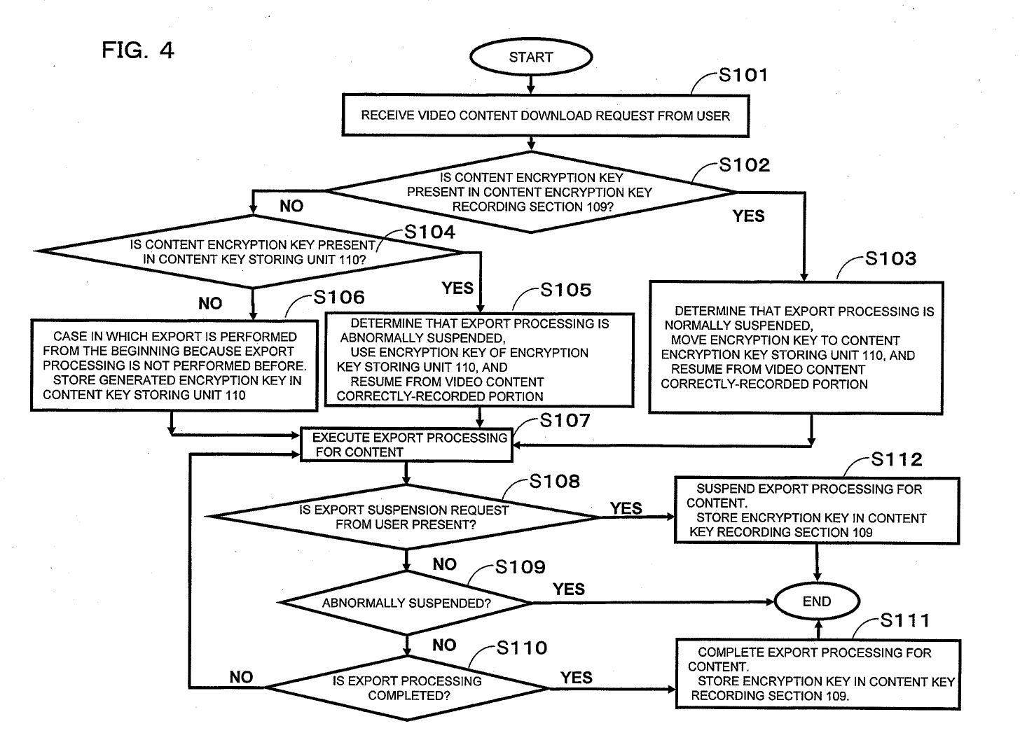

Next, a procedure for the video content export in the video receiving terminal 100 is described with reference to FIG. 4. FIG. 4 is a flowchart showing a procedure for performing export of video content in the video receiving terminal 100 according to this embodiment.

I. A case in which export of new content data is completed without suspension.

First, a user requests the video receiving terminal 100 to download certain one video content from the video server 150 and export the video content to the recording media 107.

The request receiving unit 101 receives the video content export request from the user and transmits the received video content export request to the download control unit 102 (S101).

The download control unit 102, which has received the request, transmits the export request for the video content to the export control unit 105.

The export control unit 105, which has received the export request, causes the media control unit 106 to check whether a content encryption key corresponding to the content is stored in the content encryption key recording section 109 in the recording media 107. The media control unit 106 corresponds to the unit which determines whether the content encryption key is present in the content encryption key recording section according to the present invention.

The media control unit 106 checks presence or absence of the content encryption key corresponding to the content (S102) and informs the export control unit 105 of a result of the check. In the case of I, since download and export of new content are started, the content encryption key is not present yet. Therefore, the media control unit 106 informs the export control unit 105 of that effect. In the case of I, since the content encryption key is not stored, the processing shifts to step S104.

The export control unit 105 returns the informed result to the download control unit 102.

Next, in step S104, the export control unit 105 checks whether the content encryption key corresponding to the content is stored in the content encryption key storing unit 110 incorporated in the video receiving terminal 100. In the case of I, since download and export of new content are started, the content encryption key is not present. The export control unit 105 corresponds to the unit which determines whether the content encryption key is present in the content encryption key storing unit according to the present invention.

Therefore, the export control unit 105 returns an acquired result (indicating that the content encryption key is not stored in the content encryption key storing unit 110) to the download control unit 102 (S104).

As a result, the processing shifts to step S106. In step S106, since the video content to be exported this time is video content to be exported for the first time, the export control unit 105 creates a content encryption key used for export processing of this time. For example, a method of acquiring a content encryption key from the video server 150 through the communication unit 103 and a method of generating a random number and creating a content encryption key by itself are conceivable. However, a method of creating a content encryption key is not limited to these methods. The export control unit 105 corresponds to the encryption key acquiring unit according to the present invention.

Further, the export control unit 105 stores the created content encryption key in the content encryption key storing unit 110. In this state, the content encryption key is stored in the content encryption key storing unit 110 but is not stored in the content encryption key recording section 109 of the recording media 107.

Next, in step S107, the download control unit 102 starts acquisition of video content from the video server 150 via the communication unit 103. The download control unit 102 stores the acquired video content in the buffer unit 104.

Further, the export control unit 105 encrypts the video content stored in the buffer unit 104 with the content encryption key and transmits the video content to the media control unit 106.

Further, the media control unit 106 stores the acquired encrypted video content in the content recording section 108 in the recording media 107.

Next, in steps S108 to 110, the download control unit 102 determines whether the export processing for the content is normally completed, normally suspended, or abnormally suspended because of an accident or the like. That is the download control unit 102 determines, in step S108, whether a suspension request is a normal suspension request, determines, in step S109, whether abnormal suspension has occurred, and determines, in step S110, whether the export processing for all data ends. In the case of I, since the export processing is normally completed, the processing shifts to step S111.

In step S111, after the download of the video content is completed, the download control unit 102 notifies the export control unit 105 of the download completion. The export control unit 105, which has received the notification, moves the content encryption key from the content encryption key storing unit 110 to the content encryption key recording section 109 in the recording media 107 (S111). As a result, in this state, the content encryption key is not present in the content encryption key storing unit 110 in the video receiving terminal 100 and is stored in the content encryption key recording section 109 in the recording media 107 such as a CD.

II. A case in which export of content data is normally suspended halfway

As shown in FIG. 4, first, the user requests the video receiving terminal 100 to download certain one video content from the video server 150 and export the video content to the recording media 107 (S101).

Thereafter, as described above, the processing proceeds to step S102, step S104, step S106, and step S107.

In step S108, when a normal suspension request is received halfway, the processing shifts to step S112. That is when the request receiving unit 101 receives an export suspension request from the user, the request receiving unit 101 transmits the received export suspension request to the download control unit 102. The download control unit 102, which has received the request, stops the download of the video content. At the same time, the download control unit 102 transmits the export suspension request to the export control unit 105.

The export control unit 105, which has received the request, suspends the encryption of the video content and moves the content encryption key from the content encryption key storing unit 110 to the content encryption key recording section 109 in the recording media 107 through the media control unit 106 (S112). That is when the export is suspended, since the processing has already passed through step S106, the content encryption key is stored in the content encryption key storing unit 110 and therefore the export control unit 105 moves the content encryption key from the content encryption key storing unit 110 to the content encryption key recording section 109. In this state, the content encryption key is not present in the content encryption key storing unit 110 but is present in the content encryption key recording section 109.

III. A case in which export of content data is abnormally suspended halfway

In FIG. 4, first, the user requests the video receiving terminal 100 to download certain one video content from the video server 150 and export the video content to the recording media 107 (S101).

Thereafter, as described above, the processing proceeds to step S102, step S104, step S106, and step S107.

In step S109, when a power supply for the video receiving terminal is turned off, for example, the power supply is suddenly interrupted and abnormal suspension occurs, the movement of the content encryption key is not performed and the processing ends. As a result, usually, in this situation the content encryption key remains in the content encryption key storing unit 110 and is not present in the content encryption key recording section 109 of the recording media 107.

IV. When a request for export of content data is generated anew after that

IV-1 In the case of an export request for different new video content data

Even if the content encryption key is stored in the content encryption key recording section 109 or the content encryption key storing unit 110, the content encryption key is the encryption key for the previous video content. Therefore, in this case, such processing is performed as when the content encryption key is present nowhere. As a result, the processing proceeds to step S101, step S102, step S104, step S106, and step S107 described above.

IV-2 In the case of an export request for video content data of suspension

a. When the export processing is normally suspended

In this case, since the content key is stored in the content encryption key recording section 109 in step S112, the determination in step S102 is “YES” and the processing shifts to step S103. In step S103, since the export processing is normally suspended, the export control unit 105 moves the content encryption key from the content encryption key recording section 109 to the content encryption key storing unit 110. In this state, the content encryption key is not present in the content encryption key recording section 109 but is present in the content encryption key storing unit 110.

Next, in step S107, the export control unit 105 executes export of the suspended remaining content data.

b. When the export processing is abnormally suspended and the content encryption key is present

In this case, when the export processing is abnormally suspended, as described above, in this state, the content encryption key is stored in only the content encryption key storing unit 110.

Therefore, it is determined “NO” in step S102, it is determined “YES” in step S104, and the processing shifts to step S105.

In step S105, it is determined that the export processing is abnormally suspended before. However, in this state, the content encryption key in the content encryption key storing unit 110 can be used.

In step S107, the export control unit 105 executes export of the remaining content data using the content key.

c. When the export processing is abnormally suspended and the content encryption key is not present

In this case, processing same as the processing performed in the case of the export request for the different new video content data in IV-1 described above is performed.

That is the content encryption key is not stored in the content encryption key recording section 109 and the content encryption key storing unit 110. Nevertheless, the export of the content data is still suspended. In such a case, the suspended content data remaining in the content recording section 108 is once deleted. Then, export of content data is performed anew. The processing proceeds to step S101, step S102, step S104, step S106, and step S107 described above.

By going through the procedure described above, the location of the content encryption key is as described below.

When the export is completed and when the export suspension processing is normally performed, the content encryption key is stored in the content encryption key recording section 109 in the recording media 107. When the suspension processing for the export is abnormally performed, for example, service interruption occurs or the recording media 107 is suddenly removed from the video receiving terminal 100, usually, the content encryption key is kept stored in the content encryption key storing unit 110.

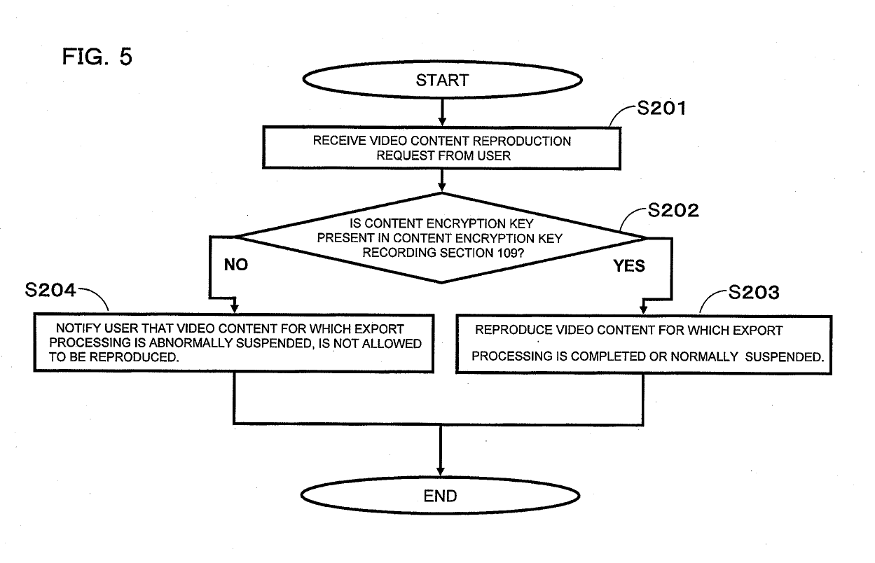

Next, reproduction permission determination for the video content stored in the recording media 107 in the video reproducing terminal 200 is described with reference to FIGS. 3 and 5. FIG. 5 is a flowchart showing a procedure for performing reproduction permission determination for the video content stored in the recording media 107 in the video reproducing terminal 200 according to this embodiment.

In FIGS. 3 and 5, first, the request receiving unit 201 in the video reproducing terminal 200 receives a video content reproduction request from the user and transmits the received video content reproduction request to the reproduction control unit 202 (S201).

The reproduction control unit 202, which has received the video reproduction request, transmits a presence check request for the content encryption key, to the media control unit 203 in order to determine reproduction permission for the video content. The media control unit 203, which has received the presence check request for the content encryption key, checks whether the content encryption key is stored in the content encryption key recording section 109 in the recording media 107 and transmits a check result to the reproduction control unit 202 (S202).

When the content encryption key is stored in the content encryption key recording section 109, it is recognized that the export processing for the exported video content is completed or, normally suspended. In that case, the reproduction control unit 202 acquires the content encryption key from the content encryption key recording section 109, decrypts the video content recorded in the content recording section 108 with the acquired content encryption key, and starts reproduction (S203). Therefore, even when the export processing is normally suspended, the partially exported content data can be reproduced.

When the content encryption key is not stored in the content encryption key recording section 109, it is recognized that the export processing for the exported video content is abnormally suspended. The reproduction control unit 202 notifies the user that the relevant video content is not allowed to be reproduced (S204). The reproduction control unit 202 corresponds to the reproduction control unit according to the present invention.

By going through the procedure described above, the video reproducing terminal can determine reproduction permission of the exported video content. When the export processing is abnormally suspended, the content encryption key necessary for decryption of the video content is left in the video receiving terminal 100. Therefore, it is possible to prevent a malicious user or unfair video reproducing terminal from reproducing the video content which has been exported halfway. As a result, when abnormal suspension occurs during the export processing, the video receiving terminal 100 can control the reproduction permission for export-incomplete content.

In brief during the export processing for the video content (S107), the content receiving terminal causes an encryption key for content stored in the recording medium, to be present in the content receiving terminal (S103, S105, and S106). Only when the export processing is completed or when suspension processing is normally performed, the content receiving terminal writes the content encryption key in the recording medium (S111 and S112). When the export processing is abnormally suspended, since the content encryption key is not stored in the recording medium, the other video reproducing terminals cannot reproduce the video content for which the export is. incomplete.

The program according to the present invention is a program for causing a computer to execute the operation in the steps of the content write-out method according to the present invention described above and is a program which operates in cooperation with the computer.

The recording medium according to the present invention is a recording medium having stored therein a program for causing a computer to execute the operation in the steps of the content write-out method according to the present invention described above and is a recording medium which is readable by the computer and the read program executes the operation in cooperation with the computer.

A utility manner of the program according to the present invention may be a form in which the program is recorded in a recording medium such as a ROM readable by a computer and operates in cooperation with the computer.

A utility manner of the program according to the present invention may be a form in which the program is transmitted through a transmission medium such as the Internet or a transmission medium such as light, a radio wave, or a sound wave, read by a computer, and operates in cooperation with the computer.

The computer described above is not limited to pure hardware such as a CPU and may include firmware, an OS, and peripheral equipment.

As described above, the configuration of the present invention may be realized in terms of software or may be realized in terms of hardware.

### INDUSTRIAL APPLICABILITY

With the content write-out method, the content receiving terminal, and the content reproducing terminal according to the present invention, when abnormal suspension occurs during export processing, it is possible to control reproduction permission for export-incomplete content in the content receiving terminal and to prevent an illegal operation in reproducing the content. Therefore, the content write-out method, the content receiving terminal, and the content reproducing terminal according to the present invention are effective in downloading video content via a communication network.

What is claimed is:

1. A content receiving terminal which encrypts content by using an encryption key and records the encrypted content in a recording media together with the encryption key, the content receiving terminal comprising:
a request receiving unit which receives a write-out request for the content from a user;
a content encryption key storing unit which stores the content encryption key; and
a control unit which controls write-out of the content and the encryption key to the recording media including a content recording section and a content encryption key recording section , wherein
the control unit includes a unit which can perform transmission and reception with at least the request receiving unit, the content encryption key storing unit, and the recording media, and determine whether the content encryption key is present in the content encryption key recording section, and
the control unit further
does not record, when the encrypted content is recorded in the content recording section of the recording media according to the write-out request for the content, the encryption key in the content encryption key recording section of the recording media but stores the encryption key in the content encryption key storing unit of the content receiving terminal,
moves, when processing for recording the encrypted content in the content recording section of the recording media is normally temporarily suspended, the encryption key stored in the content encryption key storing unit of the content receiving terminal, to the content encryption key recording section of the recording media,
does not move, when the processing for recording the encrypted content in the content recording section of the recording media is abnormally temporarily suspended, the encryption key stored in the content encryption key storing unit of the content receiving terminal, to the content encryption key recording section of the recording media,
moves, when the recording of the encrypted content is continued, if the encryption key is recorded in the content encryption key recording section of the recording media, the encryption key, to the content receiving terminal, encrypts the content, and continuously records the encrypted content in the recording media, and
moves, when the recording of the encrypted content in the recording media is completed, the encryption key, to the content key recording section of the recording media.

2. The content receiving terminal according to claim 1, wherein
the control unit further includes a unit which determines whether the content encryption key is present in the content encryption key storing unit, and
the control unit encrypts, when the recording of the encrypted content is continued, if the encryption key is not recorded in the content key recording section of the recording media and the encryption key is stored in the content key storing unit of the content receiving terminal, the content by using the stored encryption key and continuously records the encrypted content in the recording media.

3. The content receiving terminal according to claim 2, further comprising an encryption key acquiring unit which acquires an encryption key anew, wherein
the control unit acquires, when the encryption key is recorded neither in the content key recording section of the recording media nor in the content key storing unit of the content receiving terminal, an encryption key anew by the encryption key acquiring unit, encrypts the content from the beginning on the basis of the encryption key acquired anew, and performs recording of the encrypted content.

4. The content receiving terminal according to claim 3, wherein
the control unit stores, when an encryption key is created anew, the encryption key in the content encryption key storing unit of the content receiving terminal.

5. A content reproducing terminal having a function reproducing content stored in a recording media in which the content is written by the content receiving terminal according to claim 1,
the content reproducing terminal comprising a reproduction control unit which recognizes whether write-out processing for the content normally ends or abnormally ends by checking whether the encryption key for performing decryption of the content is present in the content encryption key recording section of the recording media or not.

6. A content reproducing terminal having a function reproducing content stored in a recording media in which the content is written by the content receiving terminal according to claim 2,
the content reproducing terminal comprising a reproduction control unit which recognizes whether write-out processing for the content normally ends or abnormally ends by checking whether the encryption key for performing decryption of the content is present in the content encryption key recording section of the recording media or not.

7. A content reproducing terminal having a function reproducing content stored in a recording media in which the content is written by the content receiving terminal according to claim 3,
the content reproducing terminal comprising a reproduction control unit which recognizes whether write-out processing for the content normally ends or abnormally ends by checking whether the encryption key for performing decryption of the content is present in the content encryption key recording section of the recording media or not.

8. A content reproducing terminal having a function reproducing content stored in a recording media in which the content is written by the content receiving terminal according to claim 4,
the content reproducing terminal comprising a reproduction control unit which recognizes whether write-out processing for the content normally ends or abnormally ends by checking whether the encryption key for performing decryption of the content is present in the content encryption key recording section of the recording media or not.

9. A write-out method for content in a content receiving terminal which encrypts content by using an encryption key and records the encrypted content in a recording media together with the encryption key,
the write-out method comprising:
not recording, when the encrypted content is recorded in the recording media, the encryption key, in the recording media but storing the encryption key in the content receiving terminal;
moving, when processing for recording the encrypted content in the recording media is normally temporarily suspended, the encryption key stored in the content receiving terminal, to the recording media;
not moving, when the processing for recording the encrypted content in the recording media is abnormally temporarily suspended, the encryption key stored in the content receiving terminal, to the recording media;
moving, when the recording of the encrypted content is continued, if the encryption key is recorded in the recording media, the encryption key, to the content receiving terminal, encrypting the content, and continuously recording the encrypted content in the recording media; and
moving, when the recording of the encrypted content in the recording media is completed, the encryption key to the recording media.

10. The content write-out method according to claim 9, further comprising
encrypting, when the recording of the encrypted content is continued, if the encryption key is not recorded in the recording media and the encryption key is stored in the content receiving terminal, the content by using the stored encryption key and continuously recording the encrypted content in the recording media.

11. The content write-out method according to claim 10, further comprising
creating, when the encryption key is recorded neither in the recording media nor in the content receiving terminal, an encryption key anew, encrypting the content from the beginning on the basis of the encryption key created anew, and performing recording of the encrypted content.

12. The content write-out method according to claim 11, further comprising
storing, when the encryption key is created anew, the encryption key in the content receiving terminal.

13. A program embodied on a non-transitory and tangible computer-readable medium, the program causing a computer to execute;
a write-out method for content in a content receiving terminal which encrypts content by using an encryption key and records the encrypted content in a recording media together with the encryption key, the write-out method comprising:
not recording, when the encrypted content is recorded in the recording media, the encryption key, in the recording media but storing the encryption key in the content receiving terminal;
moving, when processing for recording the encrypted content in the recording media is normally temporarily suspended, the encryption key stored in the content receiving terminal, to the recording media;
not moving, when the processing for recording the encrypted content in the recording media is abnormally suspended, the encryption key stored in the content receiving terminal, to the recording media;
moving, when the recording of the encrypted content is continued, if the encryption key is recorded in the recording media, the encryption key, to the content receiving terminal, encrypting the content, and continuously recording the encrypted content in the recording media; and
moving, when the recording of the encrypted content in the recording media is completed, the encryption key to the recording media.
